(19) United States
(12) Patent Application Publication
(10) Pub. No.: US 2020/0134534 A1
(43) Pub. Date: Apr. 30, 2020

(54) METHOD AND SYSTEM FOR DYNAMICALLY AVOIDING INFORMATION TECHNOLOGY OPERATIONAL INCIDENTS IN A BUSINESS PROCESS

(71) Applicant: WIPRO LIMITED, Bangalore (IN)

(72) Inventor: Murthy MALAPAKA, Hoffman Estates, IL (US)

(21) Appl. No.: 16/176,225

(22) Filed: Oct. 31, 2018

(51) Int. Cl. G06Q 10/06; G06N 99/00

(52) U.S. Cl. CPC G06Q 10/06393; G06N 99/005

(57) ABSTRACT

This disclosure relates to method and system for dynamically avoiding information technology (IT) operational incidents in a business process. The method may include mapping real-time unprocessed operational data with respect to an IT transaction in the business process against a dynamic baseline for each of a set of relevant key performance indicators (KPI's) for the IT transaction, and dynamically detecting an anomaly in the real-time unprocessed operational data based on the mapping. The method may further include determining, at an about time of the anomaly, one or more contemporaneous anomalies in real-time unprocessed application data and real-time unprocessed infrastructure data with respect to a plurality of applications and a plurality of components of an IT infrastructure respectively. The method may further include dynamically identifying a root cause of the anomaly by correlating the anomaly and the one or more contemporaneous anomalies, and providing the root cause for redressal.

### TECHNICAL FIELD

This disclosure relates generally to Information Technology (IT), and more particularly to method and system for dynamically avoiding IT operational incidents in a business process.

### BACKGROUND

In current business environment, organizations are increasingly deploying hybrid information technology (hybrid IT) which is a combination of public and private cloud so as to carry out various business transactions with more agility and in real-time to enhance the service availability, capacity and performance. This has resulted in very large and complex IT systems with multiple different technologies and components and handling multiple near real-time transactions. It is, therefore, important to ensure that these large and complex IT systems run smoothly with negligible operational incidents, that may cause down time or performance issues which in turn may impact quality of service and quality of end user experience.

Currently, the monitoring techniques and tools are limited in their applicability to handle a number of operational issues (i.e., incidents). For example, organizations are not able to efficiently and effectively process and correlate event and threshold data in real-time. Typically, the events are looked at by way of correlation upon occurrence of an incident. As will be appreciated, such mechanism results in a reactive response to the incident. Further, typically, the analytics are performed on persisted data that is statistic and historical and not run-time. There are challenges to conduct streaming analytics on real-time data. For example, streaming or run-time analytics needs to be supported by a platform which collates and display real-time data for a given business process or transaction from multiple sources in a unified fashion. In short, current techniques are limited in their ability to identify anomalies in a business transaction well before it manifests as an IT operational incident in either the IT application or the IT infrastructure.

### SUMMARY

In one embodiment, a method for dynamically avoiding an information technology (IT) operational incident in a business process is disclosed. In one example, the method may include mapping real-time unprocessed operational data with respect to an IT transaction in the business process against a dynamic baseline for each of a set of relevant key performance indicators (KPI's) for the IT transaction. The method may further include dynamically detecting an anomaly in the real-time unprocessed operational data based on the mapping. The method may further include determining, at an about time of the anomaly, one or more contemporaneous anomalies in real-time unprocessed application data and real-time unprocessed infrastructure data with respect to a plurality of applications and a plurality of components of an IT infrastructure respectively. The method may further include dynamically identifying a root cause of the anomaly by correlating the anomaly and the one or more contemporaneous anomalies. The method may further include providing the root cause for redressal so as to dynamically avoid the IT operational incident.

In one embodiment, a system for dynamically avoiding an IT operational incident in a business process is disclosed. In one example, the system may include an incident avoidance device, which may include at least one processor and a memory communicatively coupled to the at least one processor. The memory may store processor-executable instructions, which, on execution, may cause the processor to map real-time unprocessed operational data with respect to an IT transaction in the business process against a dynamic baseline for each of a set of relevant key performance indicators (KPI's) for the IT transaction. The processor-executable instructions, on execution, may further cause the processor to dynamically detect an anomaly in the real-time unprocessed operational data based on the mapping. The processor-executable instructions, on execution, may further cause the processor to determine, at an about time of the anomaly, one or more contemporaneous anomalies in real-time unprocessed application data and real-time unprocessed infrastructure data with respect to a plurality of applications and a plurality of components of an IT infrastructure respectively. The processor-executable instructions, on execution, may further cause the processor to dynamically identify a root cause of the anomaly by correlating the anomaly and the one or more contemporaneous anomalies. The processor-executable instructions, on execution, may further cause the processor to provide the root cause for redressal so as to dynamically avoid the IT operational incident.

In one embodiment, a non-transitory computer-readable medium storing computer-executable instructions for dynamically avoiding an IT operational incident in a business process is disclosed. In one example, the stored instructions, when executed by a processor, may cause the processor to perform operations including mapping real-time unprocessed operational data with respect to an IT transaction in the business process against a dynamic baseline for each of a set of relevant key performance indicators (KPI's) for the IT transaction. The operations may further include dynamically detecting an anomaly in the real-time unprocessed operational data based on the mapping. The operations may further include determining, at an about time of the anomaly, one or more contemporaneous anomalies in real-time unprocessed application data and real-time unprocessed infrastructure data with respect to a plurality of applications and a plurality of components of an IT infrastructure respectively. The operations may further include dynamically identifying a root cause of the anomaly by correlating the anomaly and the one or more contemporaneous anomalies. The operations may further include providing the root cause for redressal so as to dynamically avoid the IT operational incident.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for dynamically avoiding an information technology (IT) operational incident in a business process, in accordance with some embodiments of the present disclosure;

FIG. 2 is a functional block diagram of an incident avoidance engine, in accordance with some embodiments of the present disclosure;

FIG. 3 is an exemplary graphical representation for one or more anomalies in the business process along with their corresponding root cause, in accordance with some embodiments of the present disclosure;

FIG. 4 is a flow diagram of an exemplary process overview for dynamically avoiding an IT operational incident in a business process, in accordance with some embodiments of the present disclosure;

FIG. 5 is a flow diagram of an exemplary process for dynamically avoiding an IT operational incident in a business process, in accordance with some embodiments of the present disclosure; and

FIG. 6 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

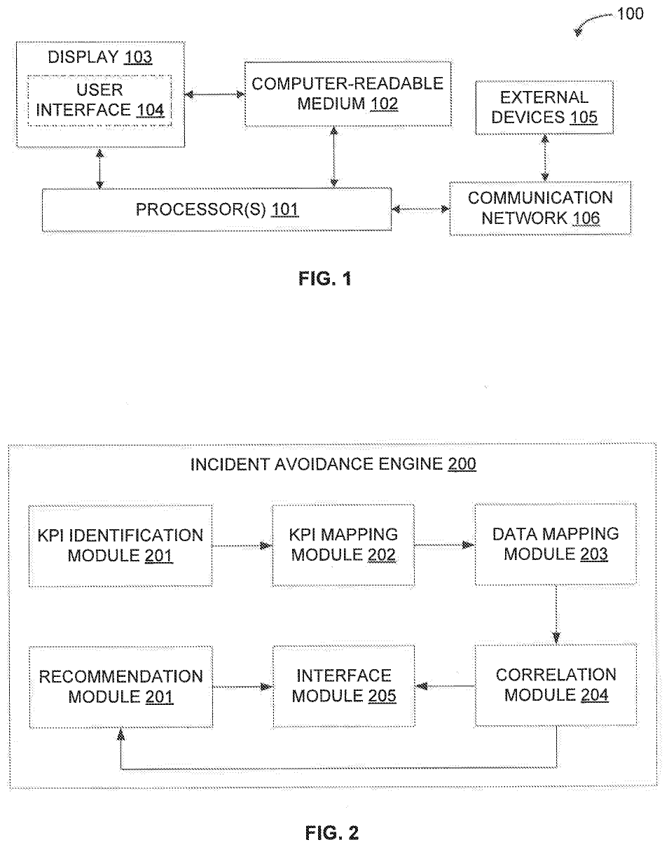

Referring now to FIG. 1, an exemplary system 100 for dynamically avoiding an information technology (IT) operational incident in a business process is illustrated, in accordance with some embodiments of the present disclosure. As will be appreciated, the system 100 may implement a number of IT applications and IT infrastructure so as enable a specific business process. Further, the system may implement an incident avoidance engine, in accordance with some embodiments of the present disclosure. The incident avoidance engine may dynamically detect anomalies, in real-time unprocessed data related to a given business process, that may lead to IT operational incident. The incident avoidance engine may further identify a root cause for anomalies and provide the root cause for redressal so as to dynamically avoid the IT operational incident in the given business process. In particular, the system 100 may include an incident avoidance device (for example, server, desktop, laptop, notebook, netbook, tablet, smartphone, mobile phone, or any other computing device) that may implement the incident avoidance engine.

As will be described in greater detail in conjunction with FIGS. 2-5, the incident avoidance engine may map real-time unprocessed operational data with respect to an IT transaction in the business process against a dynamic baseline for each of a set of relevant key performance indicators (KPI's) for the IT transaction, and dynamically detect an anomaly in the real-time unprocessed operational data based on the mapping. Additionally, the incident avoidance engine may determine, at an about time of the anomaly, one or more contemporaneous anomalies in real-time unprocessed application data and real-time unprocessed infrastructure data with respect to a plurality of applications and a plurality of components of an IT infrastructure respectively. As stated above, the plurality of applications and the plurality of components of an IT infrastructure enables the business process. Further, the incident avoidance engine may dynamically identify a root cause of the anomaly by correlating the anomaly and the one or more contemporaneous anomalies. Moreover, the incident avoidance engine may provide the root cause for redressal so as to dynamically avoid the IT operational incident.

The system 100 may include one or more processors 101, a computer-readable medium (for example, a memory) 102, and a display 103. The computer-readable storage medium 102 may store instructions that, when executed by the one or more processors 101, cause the one or more processors 101 to dynamically avoid an IT operational incident in a business process, in accordance with aspects of the present disclosure. The computer-readable storage medium 102 may also store various data (for example, pre-defined key performance indicators (KPI's) for various IT transactions, relevant KPI's for an IT transaction, dynamic baseline for each relevant KPI, detected anomalies in real-time unprocessed operational data, real-time unprocessed application data at an about time of each anomaly, real-time unprocessed infrastructure data at an about time of each anomaly, one or more contemporaneous anomalies in the real-time unprocessed application data and the real-time unprocessed infrastructure data, a root cause for each anomaly, natural language description for each anomaly and corresponding root cause, recommended action to redress each root cause, and the like) that may be captured, processed, and/or required by the system 100. The system 100 may interact with a user via a user interface 104 accessible via the display 103. The system 100 may also interact with one or more external devices 105 over a communication network 106 for sending or receiving various data. The external devices 105 may include, but may not be limited to, a remote server, a digital device, or another computing system.

Referring now to FIG. 2, a functional block diagram of an incident avoidance engine 200, implemented by the system 100 of FIG. 1, is illustrated, in accordance with some embodiments of the present disclosure. The incident avoidance engine 200 may include various modules that perform various functions so as to analyze and understand anomalies and their corresponding root causes in a synthetic IT transaction within a business process and to provide for redressals of the root causes so as to dynamically avoid any IT operational incidents in the business process. As will be appreciated, the synthetic transaction may be a line action in the business process at that point in time. In some embodiments, the incident avoidance engine 200 may include a KPI identification module 201, a KPI mapping module 202, a data mapping module 203, a correlation module 204, an interface module 205, and a recommendation module 206. As will be appreciated by those skilled in the art, all such aforementioned modules 201-206 may be represented as a single module or a combination of different modules. Moreover, as will be appreciated by those skilled in the art, each of the modules 201-206 may reside, in whole or in parts, on one device or multiple devices in communication with each other.

The KPI identification module 201 may identify a set of relevant KPI's for a synthetic IT transaction in a business process from among a number of pre-defined KPI's for the business process. Additionally, the KPI identification module 201 may determine a dynamic baseline for each of the set of relevant KPI's in real-time using at least one of a statistical pattern discovery model, or a machine learning model. It should be noted that the KPI identification module 201 may, generally, obtain KPI's from IT components that may fulfill condition for KPIs. Further, it should be noted that the KPI identification module 201 may also provide data required to measure KPI's.

The KPI identification module 201 may receive real-time unprocessed operational data with respect to an IT transaction in a business process. As will be appreciated, the real-time unprocessed operational data may be a streaming data for an identified time series. Upon receiving the streaming data for the identified time series, the KPI identification module 201 may provide for translation of data according to message delivery. Upon data translation, the KPI identification module 201 may provide for integration and reliable message delivery. Further, the KPI identification module 201 may process message data and store the processed data in a big data store. The KPI identification module 201 may then employ pattern discovery algorithms on the stored data for identifying relevant KPI's and for determining dynamic baseline for each of the relevant KPI's. In other words, the KPI identification module 201 may learn to first identify a right set of KPI's and avoid any unnecessary KPI's for a given synthetic transaction in the business process. Further, the KPI identification module 201 may learn to identify a right set of attributes and avoid any unnecessary attributes for each of the identified KPI's so as to dynamically determine the baseline for that KPI.

As will be appreciated, the incident avoidance engine 200 may receive the streaming data for the identified time series visualization requirement through various listeners and adapters communicatively coupled to various monitoring systems or instrumentation logs (for example, by way of a message bus). Further, it should be noted that the pattern detection of time series data may be conducted using statistical pattern discovery model or machine learning based pattern discovery model (e.g., artificial intelligence model). As will be appreciated, the specific pattern discovery model may be custom built on specific KPI's identified for specific business processes. Further, a good state pattern may be created and stored in the big data store.

The KPI mapping module 202 may map the real-time unprocessed operational data of specific business process against the relevant KPI's. In particular, the KPI mapping module 202 may map the real-time unprocessed operational data with respect to the IT transaction in the business process against a dynamic baseline for each of a set of relevant key performance indicators (KPI's) for the IT transaction. The KPI mapping module 202 may further dynamically detect an anomaly in the real-time unprocessed operational data based on the mapping. As will be appreciated, there are a number of business processes running across enterprise situation. Thus, KPI's acquired through data discovery by the KPI identification module 201 may be fed into streaming analytics so as to develop synthetic transaction maps, which may provide topology for IT applications.

The data mapping module 203 may determine, at an about time of the anomaly, real-time unprocessed application data and real-time unprocessed infrastructure data with respect to a plurality of applications and a plurality of components of an IT infrastructure (for example, data center, network, etc.) respectively. As will be appreciated, the plurality of applications and the IT infrastructure may enable the business process. Further, as will be appreciated, the real-time unprocessed application data and the real-time unprocessed infrastructure data may be a streaming data for an identified time series.

It should be noted that the data mapping module 203 may receive the real-time unprocessed application data and the real-time unprocessed infrastructure data from the data storage or infrastructure sources. The data storage or infrastructure sources may generally contain data related to business application logs, application instrumentations, web, middleware logs, or the like. As will be described in detail below, the integrated data may enable the incident avoidance engine 200 to provide end to end monitoring data as live streams and event data. The streaming analytics with combination of big data running on data storage system may process and identify complex events.

Further, it should be noted that the above streaming data for the identified time series may not be stored or persisted until the detection of the anomaly in the real-time unprocessed operational data. However, upon detection of the anomaly, the KPI identification module 201 or the KPI mapping module 202 may store or persist on the real-time unprocessed operational data within a pre-defined time window of the about time of the anomaly. Similarly, the data mapping module 203 may store or persist on the real-time unprocessed application data and the real-time unprocessed infrastructure data within the pre-defined time window of the about time of the anomaly.

The correlation module 204 may determine one or more contemporaneous anomalies in the real-time unprocessed application data and real-the time unprocessed infrastructure data. The correlation module 204 may then dynamically identify a root cause of the anomaly by correlating the anomaly and the one or more contemporaneous anomalies. In other words, the streaming data from multiple sources at the about time of anomaly may be analyzed to determine one or more contemporaneous anomalies. The anomaly and the one or more contemporaneous anomalies may then be correlated to identify exact “cause” of the anomaly. It should be noted that, in some embodiments, the correlation module 204 may have complex event processing capabilities so as to identify one or more events within the pre-defined time window of the about time of the anomaly. Additionally or alternatively, in some embodiments, the correlation may involve determining at least one of a deviation from a good state, or a non-compliance to an expected state. Thus, the exact “cause” may be determined using the “good state” data.

The interface module 205 may provide the detected anomalies and the identified root causes for redressal so as to dynamically avoid the IT operational incident. In some embodiments, the interface module 205 may provide customized or standardized remediation via alerts or visualization subsequent to correlation (e.g., complex event processing). For example, the interface module 205 may provide visualization of the detected anomalies and the identified root causes for display to a user (e.g., member of a resolution team). It should be noted that the interface module 205 may publish the detected anomalies and the identified root causes to the user via a dashboard. Additionally or alternatively, in some embodiments, the interface module 205 may provide a natural language description (for example, simple English) of the detected anomalies and the identified root causes to the user. For example, the anomalies and their corresponding root causes may be visually shown in simple English with very specific pointers. By way of an example, the interface module 205 may indicate a payment gateway failure due to a network error in vlan xxx connected to interface xxx or may indicate inability to complete a write operation due to a dead lock problem in oracle server xxx and database yyy.

In some embodiments, the incident avoidance engine 200 may further include a recommendation module 206 that may determine a recommended action to redress the root cause of the anomaly. In such embodiments, the interface module 205 may further provide the recommended action to a user. Additionally, in such embodiments, the incident avoidance engine 200 may implement the recommended action so as to avoid the IT operational incident. It should be noted that the implementation of the recommended action may be upon an approval from the user.

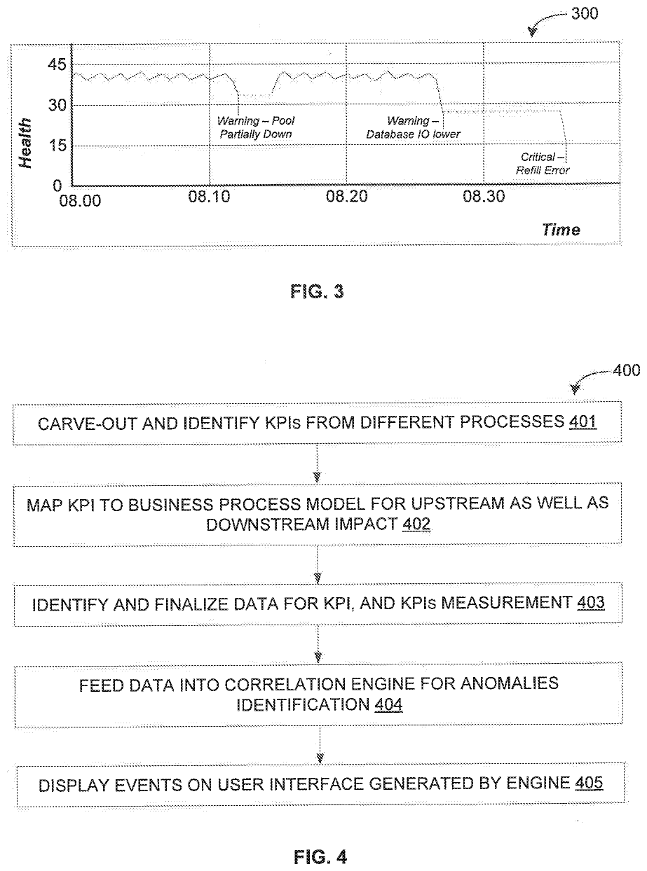

Referring now to FIG. 3, an exemplary graphical representation 300 for one or more anomalies in the business process along with their corresponding root cause is illustrated, in accordance with some embodiments of the present disclosure. The real-time graph 300 of the time series data provides a visual representation of a health or heartbeat of an enterprise. The real-time graph 300 indicates one or more anomalies in real-time along with their identified root causes in easy to understand natural language. Such real-time graph 300 may enable the user to deep dive and redress the root cause in real-time.

By way of example, in an order to cash system there is a drop in the number of orders as per a dynamic baseline. Such drop may create an anomaly event and immediately all the underlying environment data may be scanned so as to identify which system is causing the drop using the anomalies in those data streams as per their individual baselines. The same may be shown in the visualization in a simple readable format such as “sales order process slow due to memory low on server ABC please allocate more swap space”.

As will be appreciated, managing hybrid IT environments require providing proactive control of service capacity, performance and availability in real-time along with an interface having a single pane visualization due to inherent on demand and real-time nature of the business process. Further, hybrid environments require reducing wastage of time through hops by accurately assigning problems, reducing time to restore service, and providing 100% availability of service capability. The visualization is used to provide real-time insight of a business process anomalies with previously learnt good state before it becomes an incident so as to avoid any incident from occurring. In other words, visualization is required to provide ability to show real-time insight of the root cause well before it is an incident and to create actions that can bring back the service to normalcy even before it has impacted user delight. Moreover, visualization may require the system to keep learning the KPI's of the business process and pass them to incidence avoidance engine 200. This may help reduce or avoid business stake holder requirement for KPI data and may provide single-click root cause identification on the anomaly so as to assign relevant subject matter expert (SME) required to analyze and restore service.

The incident avoidance engine 200, described in the embodiments discussed above, may provide correlation of several real-time data points so as to dynamically detect anomalies in a synthetic IT transaction within a business process before it manifests as an incident in either the application or the infrastructure and potentially cause service interruption. In other words, incident avoidance engine 200 analyze the raw wire data streamed in real-time so as predict a future operational IT incident based on detected anomalies and prevent the same by providing for the redressal of the root cause of the detected anomalies. Further, the incident avoidance engine 200 may provide a visualization of such anomalies along with their root causes expressed in a simple readable format. Moreover, the incident avoidance engine 200 may provide recommended actions that needs to be taken for the service to be restored to normalcy before it becomes an incident.

The incident avoidance engine 200, described in the embodiments discussed above, may also identify business process KPI's so as to measure the health of the enterprise without human intervention. The incident avoidance engine 200 may further provide for real-time learning and feedback loop that may adjust to business ups and downs, and to any other third-party influences that may create spike in application usage. Also, the incident avoidance engine 200 express the anomaly in a simple understandable form that can be communicated to business.

It should be noted that the incident avoidance engine 200 may be implemented in programmable hardware devices such as programmable gate arrays, programmable array logic, programmable logic devices, and so forth. Alternatively, the incident avoidance engine 200 may be implemented in software for execution by various types of processors. An identified engine of executable code may, for instance, include one or more physical or logical blocks of computer instructions which may, for instance, be organized as an object, procedure, function, module, or other construct, Nevertheless, the executables of an identified engine need not be physically located together, but may include disparate instructions stored in different locations which, when joined logically together, include the engine and achieve the stated purpose of the engine. Indeed, an engine of executable code could be a single instruction, or many instructions, and may even be distributed over several different code segments, among different applications, and across several memory devices.

Referring now to FIG. 4, an overview of an exemplary process 400 for dynamically avoiding an IT operational incident in a business process is depicted via a flowchart, in accordance with some embodiments of the present disclosure. At step 401, the KPI identification module 201 may carve-out and identify KPI's from different processes. Further, at step 402, the KPI mapping module 202 may map the KPI to business process for upstream as well as downstream impact by automatically identifying KPI's of application and infrastructure operational data against the good state KPI's of the business process or upstream KPI's. Further, at step 403, the data mapping module 203 may identify and finalize data for KPI measurement. The data mapping module 203 may then feed the data to the correlation module 204. Further, at step 404, the correlation module 204 may correlate the data so as to identify anomalies and their root causes. Further, at step 405, the interface module 205 may display events (corresponding to anomalies and their root causes) on a user interface.

As will be appreciated, the above discussed process is a visualization driven process. Thus, the above discussed process is basically dependent on the “each individual specific visualization” that may get created first and then analytics may be built for that visualization. Initially, a visual representation of streaming data may be created. The data may be streamed from multiple data sources to show a time series good state for identified business processes. The streaming analytics enabled by pattern discovery model may receive the data stream and may constantly compare the same with a “good state” provided through the KPI values already identified. Upon detecting an anomaly, the same may be visually indicated (e.g., as an amber colored dot) and also the corresponding anomaly in the underlying systems may be identified and read out as a mouse over on the visual indication. Upon clicking or hovering over the visual indication, the root cause may be made available for subsequent action and redressal.

The above discussed process may identify KPI's from different stakeholders such as business owners, IT owners, support partner, and data discovery platform. After identifying KPI's, the KPIs are mapped based upon the different business process model. This mapping is required so that upstream and downstream impact may be visually understood. Further, for KPI measurement, there is a need to identify what data is required, from where it has to be extracted, how it has to be extracted, etc. Thus, the above described process may finalize the data for KPI measurement based on number of factors. For example, data finalization may depend upon data source (i.e. from where the data is originating such as from Oracle, Microsoft, or SAP applications), method of data collection (i.e. whether data is collected via pull or push method), and so forth. Moreover, IT infrastructure data may be collected from different servers, network nodes and storage systems. After data finalization for measuring KPI's, the finalized data may be fed into a correlation module 204 that may perform complex event processing of different data and may identify an anomaly. The correlation module 204 may be fed with application and infrastructure data using message bus. It should be noted that the application and infrastructure data may be processed based on machine learning or artificial intelligence based model. Upon modeling of the data by the correlation module 204, events (e.g., corresponding to root causes) may be generated. The events are then generally pulled and published. In other words, the events may then be visually indicated on the user interface and to create different actions. The interface module 205 may provide health dashboard which may display enterprise and business processes anomalies along with their root causes. Further, actions may be taken based on the identified anomalies and their root causes.

As will be appreciated by one skilled in the art, a variety of processes may be employed for dynamically avoiding an IT operational incident in a business process. For example, the exemplary system 100 and the associated incident avoidance engine 200 may dynamically avoid IT operational incidents by the processes discussed herein. In particular, as will be appreciated by those of ordinary skill in the art, control logic and/or automated routines for performing the techniques and steps described herein may be implemented by the system 100 and the incident avoidance engine 200, either by hardware, software, or combinations of hardware and software. For example, suitable code may be accessed and executed by the one or more processors on the system 100 to perform some or all of the techniques described herein. Similarly, application specific integrated circuits (ASICs) configured to perform some or all of the processes described herein may be included in the one or more processors on the system 100.

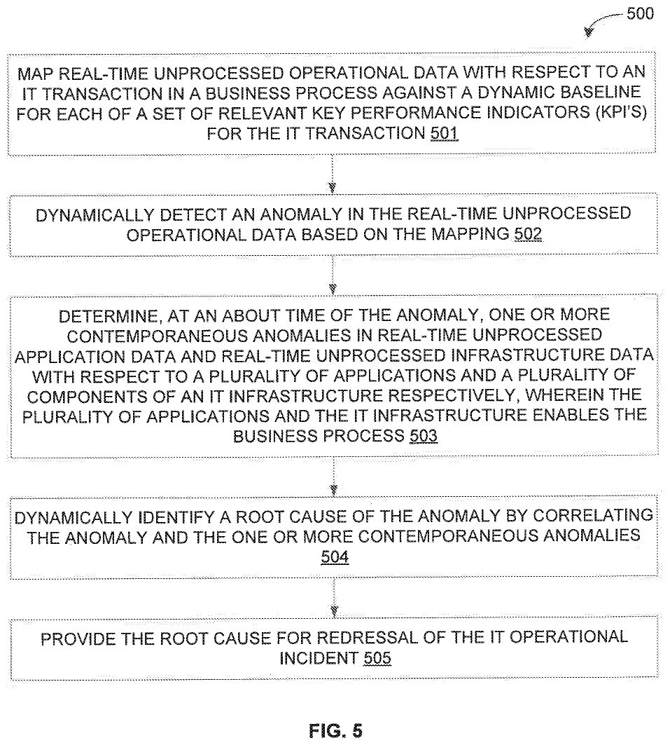

For example, referring now to FIG. 5, exemplary control logic 500 for dynamically avoiding an IT operational incident in a business process via a system, such as the system 100, is depicted via a flowchart, in accordance with some embodiments of the present disclosure. As illustrated in the flowchart, the control logic 500 may include the steps of mapping real-time unprocessed operational data (for example, from various monitoring and instrumentation sources) with respect to an IT transaction in the business process against a dynamic baseline for each of a set of relevant key performance indicators (KPI's) for the IT transaction at step 501, dynamically detecting an anomaly in the real-time unprocessed operational data based on the mapping at step 502, and determining, at an about time of the anomaly, one or more contemporaneous anomalies in real-time unprocessed application data and real-time unprocessed infrastructure data with respect to a plurality of applications and a plurality of components of an IT infrastructure respectively at step 503. It should be noted that the plurality of applications and the IT infrastructure may enable the business process. The control logic 500 may further include the steps of dynamically identifying a root cause of the anomaly by correlating the anomaly and the one or more contemporaneous anomalies at step 504, and providing the root cause for redressal so as to dynamically avoid the IT operational incident at step 505.

In some embodiments, the control logic 500 may further include the step of streaming without persisting, until dynamically detecting the anomaly, the real-time unprocessed operational data, the real-time unprocessed application data, and the real-time unprocessed infrastructure data. Additionally, in some embodiments, the control logic 500 may further include the step of persisting, upon dynamically detecting the anomaly, on the real-time unprocessed application data and the real-time unprocessed infrastructure data within a pre-defined time window of the about time of the anomaly.

In some embodiments, the control logic 500 may further include the steps of identifying the set of relevant KPI's for the IT transaction from among a plurality of pre-defined KPI's, and determining the dynamic baseline for each of the set of relevant KPI's in real-time using at least one of a statistical pattern discovery model, or a machine learning model. Additionally, in some embodiments, the control logic 500 may further include the step of providing visualization of the anomaly and of the root cause of the anomaly to a user. Moreover, in some embodiments, the control logic 500 may further include the step of providing a natural language description of the anomaly and of the root cause of the anomaly to the user.

In some embodiments, correlating at step 504 may include performing complex event processing to identify one or more events within the pre-defined time window of the about time of the anomaly. Additionally, in some embodiments, correlating at step 504 may include determining at least one of a deviation from a good state, or a non-compliance to an expected state. Further, in some embodiments, providing the root cause for redressal at step 505 may include determining a recommended action to redress the root cause of the anomaly. Further, in some embodiments, providing the root cause for redressal at step 505 may include at least one of providing the recommended action to a user, or implementing the recommended action.

As will be also appreciated, the above described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

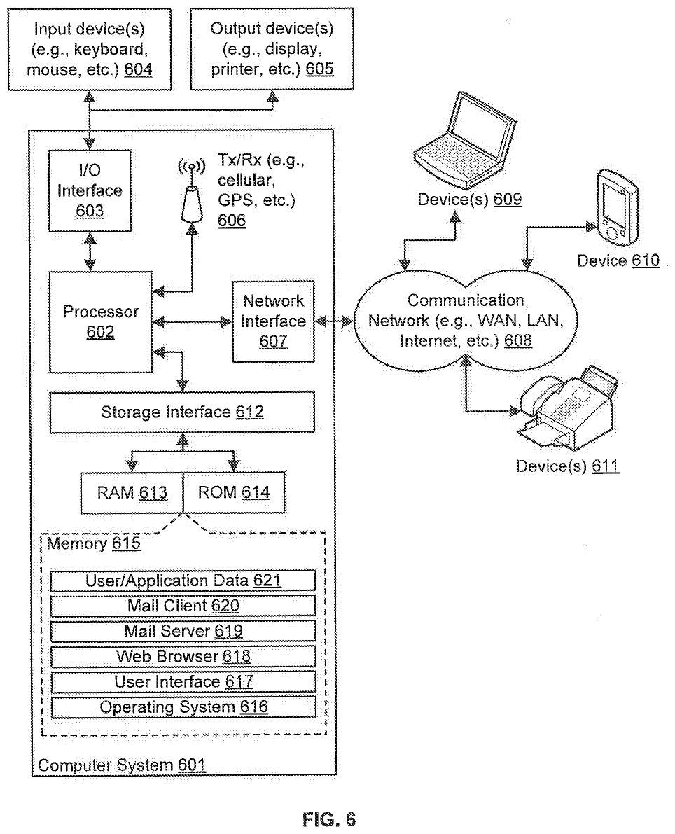

The disclosed methods and systems may be implemented on a conventional or a general-purpose computer system, such as a personal computer (PC) or server computer, Referring now to FIG. 6, a block diagram of an exemplary computer system 601 for implementing embodiments consistent with the present disclosure is illustrated. Variations of computer system 601 may be used for implementing system 100 for dynamically avoiding an IT operational incident in a business process. Computer system 601 may include a central processing unit (“CPU” or “processor”) 602. Processor 602 may include at least one data processor for executing program components for executing user-generated or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD® ATHLON®, DURON® OR OPTERON®, ARM's application, embedded or secure processors, IBM® POWERPC®, INTEL® CORE® processor, ITANIUM® processor, XEON® processor, CELERON® processor or other line of processors, etc. The processor 602 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 602 may be disposed in communication with one or more input/output (I/O) devices via I/O interface 603. The I/O interface 603 may employ communication protocols/methods such as, without limitation, audio, analog, digital, monoaural, RCA, stereo, IEEE-1394, near field communication (NFC), FireWire, Camera Link®, GigE, serial bus, universal serial bus (USB), infrared, PS/2, BNC, coaxial, component, composite, digital visual interface (DVI), high-definition multimedia interface (HDMI), radio frequency (RF) antennas, S-Video, video graphics array (VGA), IEEE 802.n /b/g/n/x, Bluetooth, cellular (e.g., code-division multiple access (CDMA), high-speed packet access (HSPA+), global system for mobile communications (GSM), long-term evolution (LTE), WiMAX, or the like), etc.

Using the I/O interface 603, the computer system 601 may communicate with one or more I/O devices. For example, the input device 604 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, altimeter, gyroscope, proximity sensor, or the like), stylus, scanner, storage device, transceiver, video device/source, visors, etc. Output device 605 may be a printer, fax machine, video display (e.g., cathode ray tube (CRT), liquid crystal display (LCD), light-emitting diode (LED), plasma, or the like), audio speaker, etc. In some embodiments, a transceiver 606 may be disposed in connection with the processor 602. The transceiver may facilitate various types of wireless transmission or reception. For example, the transceiver may include an antenna operatively connected to a transceiver chip (e.g., TEXAS INSTRUMENTS® WILINK WL1286®, BROADCOM® BCM4550IUB8®, INFINEON TECHNOLOGIES® X-GOLD 618-PMB9800® transceiver, or the like), providing IEEE 802,11a/b/g/n, Bluetooth, FM, global positioning system (GPS), 2G/3G HSDPA/HSUPA communications, etc.

In some embodiments, the processor 602 may be disposed in communication with a communication network 608 via a network interface 607. The network interface 607 may communicate with the communication network 608. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 608 may include, without limitation, a direct interconnection, local area network (LAN), wide area network (WAN), wireless network (e.g., using Wireless Application Protocol), the Internet, etc. Using the network interface 607 and the communication network 608, the computer system 601 may communicate with devices 609, 610, and 611. These devices may include, without limitation, personal computer(s), server(s), fax machines, printers, scanners, various mobile devices such as cellular telephones, smartphones (e.g., APPLE® IPHONE®, BLACKBERRY® smartphone, ANDROID® based phones, etc.), tablet computers, eBook readers (AMAZON® KINDLE®, NOOK® etc.), laptop computers, notebooks, gaming consoles (MICROSOFT® XBOX®, NINTENDO® DS®, SONY® PLAYSTATION®, etc.), or the like. In some embodiments, the computer system 601 may itself embody one or more of these devices.

In some embodiments, the processor 602 may be disposed in communication with one or more memory devices (e.g., RAM 613, ROM 614, etc.) via a storage interface 612. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), STD Bus, RS-232, RS-422, RS-485, I2C, SPI, Microwire, 1-Wire, IEEE 1284, Intel® QuickPathInterconnect, InfiniBand, PCIe, etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 616, user interface application 617, web browser 618, mail server 619, mail client 620, user/application data 621 (e.g., any data variables or data records discussed in this disclosure), etc. The operating system 616 may facilitate resource management and operation of the computer system 601. Examples of operating systems include, without limitation, APPLE® MACINTOSH® OS X, UNIX, Unix-like system distributions (e.g., Berkeley Software Distribution (BSD), FreeBSD, NetBSD, OpenBSD, etc.), Linux distributions (e.g., RED HAT®, UBUNTU®, KUBUNTU®, etc.), IBM® OS/2, MICROSOFT® WINDOWS® (XP®, Vista®/7/8, etc.), APPLE® IOS®, GOOGLE® ANDROID®, BLACKBERRY® OS, or the like. User interface 617 may facilitate display, execution, interaction, manipulation, or operation of program components through textual or graphical facilities. For example, user interfaces may provide computer interaction interface elements on a display system operatively connected to the computer system 601, such as cursors, icons, check boxes, menus, scrollers, windows, widgets, etc. Graphical user interfaces (GUIs) may be employed, including, without limitation, APPLE® MACINTOSH® operating systems' AQUA® platform, IBM® OS/2®, MICROSOFT® WINDOWS® (e.g., AERO®, METRO®, etc.), UNIX X-WINDOWS, web interface libraries (e.g., ACTIVEX®, JAVA®, JAVASCRIPT®, AJAX®, HTML, ADOBE® FLASH®, etc.), or the like.

In some embodiments, the computer system 601 may implement a web browser 618 stored program component. The web browser may be a hypertext viewing application, such as MICROSOFT® INTERNET EXPLORER®, GOOGLE® CHROME®, MOZILLA® FIREFOX®, APPLE® SAFARI®, etc. Secure web browsing may be provided using HTTPS (secure hypertext transport protocol), secure sockets layer (SSL), Transport Layer Security (TLS), etc. Web browsers may utilize facilities such as AJAX®, DHTML, ADOBE® FLASH®, JAVASCRIPT®, JAVA®, application programming interfaces (APIs), etc. In some embodiments, the computer system 601 may implement a mail server 619 stored program component. The mail server may be an Internet mail server such as MICROSOFT® EXCHANGE®, or the like. The mail server may utilize facilities such as ASP. ActiveX, ANSI C++/C #, MICROSOFT .NET® CGI scripts, JAVA®, JAVASCRIPT®, PERL®, PHP®, PYTHON®, WebObjects, etc. The mail server may utilize communication protocols such as Internet message access protocol (IMAP), messaging application programming interface (MAPI), MICROSOFT® EXCHANGE®, post office protocol (POP), simple mail transfer protocol (SMTP), or the like. In some embodiments, the computer system 601 may implement a mail client 620 stored program component. The mail client may be a mail viewing application, such as APPLE MAIL®, MICROSOFT ENTOURAGE®; MICROSOFT OUTLOOK®, MOZILLA THUNDERBIRD®, etc.

In some embodiments, computer system 601 may store user/application data 621, such as the data, variables, records, etc. (e.g., pre-defined key performance indicators (KPI's) for various IT transactions, relevant KPI's for an IT transaction, dynamic baseline for each relevant KPI, detected anomalies in real-time unprocessed operational data, real-time unprocessed application data at an about time of each anomaly, real-time unprocessed infrastructure data at an about time of each anomaly, one or more contemporaneous anomalies in the real-time unprocessed application data and the real-time unprocessed infrastructure data, a root cause for each anomaly, natural language description for each anomaly and corresponding root cause, recommended action to redress each root cause, and so forth) as described in this disclosure. Such databases may be implemented as fault-tolerant, relational, scalable, secure databases such as ORACLE® OR SYBASE®. Alternatively, such databases may be implemented using standardized data structures, such as an array, hash, linked list, struct, structured text file (e.g., XML), table, or as object-oriented databases (e.g., using OBJECTSTORE®, POET®, ZOPE®, etc.). Such databases may be consolidated or distributed, sometimes among the various computer systems discussed above in this disclosure. It is to be understood that the structure and operation of the any computer or database component may be combined, consolidated, or distributed in any working combination.

As will be appreciated by those skilled in the art, the techniques described in the various embodiments discussed above are not routine, or conventional, or well understood in the art. The techniques discussed above provide for avoiding an IT operational incident in a business process through unique visualization of health of the business process and by enabling actions to restore normalcy. The aspects of unique visualization include integrated view of business process through a single console. Such visualization is enabled by integration of several data sources and detection of anomalies based on a dynamic baseline. In other words, the good state is defined based on the dynamic baseline and not static baseline. The visualization may also enable, standard or customized, mouse-over root cause indication or single-click root cause analysis. Additionally, the techniques also provide for natural language description of the root cause that may help anyone from service desk engineers to NOC engineers, and enable the organization to avoid requirement of cost intensive subject matter experts (SMEs) for most of the problems. Further, the techniques also provide for creation of redressal actions for self-healing based on the pattern identification.

Further, as will be appreciated, the techniques described above provides for anomaly detection in a business service and not in the IT infrastructure. It should be noted that the techniques work using synthetic transaction and dynamic topology which is more relevant to the hybrid IT world. Moreover, the techniques provide for automated KPI identification and improvement using machine learning which is, typically, a cumbersome process.

The specification has described method and system for dynamically avoiding an IT operational incident in a business process. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method of dynamically avoiding an information technology operational incident in a business process, the method comprising:
mapping, by an incident avoidance device, real-time unprocessed operational data with respect to an information technology (IT) transaction in the business process against a dynamic baseline for each of a set of relevant key performance indicators (KPI's) for the IT transaction;
dynamically detecting, by the incident avoidance system, an anomaly in the real-time unprocessed operational data based on the mapping;
determining, by the incident avoidance system at an about time of the anomaly, one or more contemporaneous anomalies in real-time unprocessed application data and real-time unprocessed infrastructure data with respect to a plurality of applications and a plurality of components of an IT infrastructure respectively, wherein the plurality of applications and the IT infrastructure enables the business process;
dynamically identifying, by the incident avoidance system, a root cause of the anomaly by correlating the anomaly and the one or more contemporaneous anomalies; and
providing, by the incident avoidance system, the root cause for redressal so as to dynamically avoid the IT operational incident.

2. The method of claim 1, further comprising:
streaming without persisting, until dynamically detecting the anomaly, the real-time unprocessed operational data, the real-time unprocessed application data, and the rear-time unprocessed infrastructure data.

3. The method of claim 1, further comprising:
identifying the set of relevant KPI's for the IT transaction from among a plurality of pre-defined KPI's; and
determining the dynamic baseline for each of the set of relevant KPI's in real-time using at least one of a statistical pattern discovery model, or a machine learning model.

4. The method of claim 1, further comprising:
persisting, upon dynamically detecting the anomaly, on the real-time unprocessed application data and the real-time unprocessed infrastructure data within a pre-defined window of the about time of the anomaly.

5. The method of claim 1, wherein the correlating comprises performing complex event processing to identify one or more events within a pre-defined time window of the about time of the anomaly.

6. The method of claim 1, wherein the correlating comprises determining at least one of a deviation from a good state, or a non-compliance to an expected state.

7. The method of claim 1, further comprising at least one of:
providing visualization of the anomaly and of the root cause of the anomaly to a user, or
providing a natural language description of the anomaly and of the root cause of the anomaly to the user.

8. The method of claim 1, wherein providing the root cause for redressal further comprises:
determining a recommended action to redress the root cause of the anomaly; and
at least one of providing the recommended action to a user, or implementing the recommended action.

9. A system for dynamically avoiding an information technology operational incident in a business process, the system comprising:
an incident avoidance device comprising at least one processor and a computer-readable medium storing instructions that, when executed by the at least one processor, cause the at least one processor to perform operations comprising:
mapping real-time unprocessed operational data with respect to an information technology (IT) transaction in the business process against a dynamic baseline for each of a set of relevant key performance indicators (KPI's) for the IT transaction;
dynamically detecting an anomaly in the real-time unprocessed operational data based on the mapping;
determining, at an about time of the anomaly, one or more contemporaneous anomalies in real-time unprocessed application data and real-time unprocessed infrastructure data with respect to a plurality of applications and a plurality of components of an IT infrastructure respectively, wherein the plurality of applications and the IT infrastructure enables the business process;
dynamically identifying a root cause of the anomaly by correlating the anomaly and the one or more contemporaneous anomalies; and
providing the root cause for redressal so as to dynamically avoid the IT operational incident.

10. The system of claim 9, wherein the operations further comprise:
streaming without persisting, until dynamically detecting the anomaly, the real-time unprocessed operational data, the real-time unprocessed application data, and the real-time unprocessed infrastructure data.

11. The system of claim 9, wherein the operations further comprise:
identifying the set of relevant KPI's for the IT transaction from among a plurality of pre-defined KPI's; and
determining the dynamic baseline for each of the set of relevant KPI's in real-time using at least one of a statistical pattern discovery model, or a machine learning model.

12. The system of claim 9, wherein the operations further comprise:
persisting, upon dynamically detecting the anomaly, on the real-time unprocessed application data and the real-time unprocessed infrastructure data within a pre-defined window of the about time of the anomaly.

13. The system of claim 9, wherein the correlating comprises performing complex event processing to identify one or more events within a pre-defined time window of the about time of the anomaly.

14. The system of claim 9, wherein the correlating comprises determining at least one of a deviation from a good state, or a non-compliance to an expected state.

15. The system of claim 9, wherein the operations further comprise at least one of:
providing visualization of the anomaly and of the root cause of the anomaly to a user, or
providing a natural language description of the anomaly and of the root cause of the anomaly to the user.

16. The system of claim 9, wherein providing the root cause for redressal further comprises:
determining a recommended action to redress the root cause of the anomaly; and
at least one of providing the recommended action to a user, or implementing the recommended action.

17. A non-transitory computer-readable medium storing computer-executable instructions for dynamically avoiding an information technology operational incident in a business process, the computer-executable instructions configured for:
mapping real-time unprocessed operational data with respect to an information technology (IT) transaction in the business process against a dynamic baseline for each of a set of relevant key performance indicators (KPI's) for the IT transaction;
dynamically detecting an anomaly in the real-time unprocessed operational data based on the mapping;
determining, at an about time of the anomaly, one or more contemporaneous anomalies in real-time unprocessed application data and real-time unprocessed infrastructure data with respect to a plurality of applications and a plurality of components of an IT infrastructure respectively, wherein the plurality of applications and the IT infrastructure enables the business process;
dynamically identifying a root cause of the anomaly by correlating the anomaly and the one or more contemporaneous anomalies; and
providing the root cause for redressal so as to dynamically avoid the IT operational incident.

18. The non-transitory computer-readable medium of claim 17, wherein the computer-executable instructions are further configured for at least one of:
streaming without persisting, until dynamically detecting the anomaly, the real-time unprocessed operational data, the real-time unprocessed application data, and the real-time unprocessed infrastructure data, or
persisting, upon dynamically detecting the anomaly, on the real-time unprocessed application data and the real-time unprocessed infrastructure data within a pre-defined window of the about time of the anomaly.

19. The non-transitory computer-readable medium of claim 17, wherein the computer-executable instructions are further configured for:
identifying the set of relevant KPI's for the IT transaction from among a plurality of pre-defined KPI's; and
determining the dynamic baseline for each of the set of relevant KPI's in real-time using at least one of a statistical pattern discovery model, or a machine learning model.

20. The non-transitory computer-readable medium of claim 17, wherein the computer-executable instructions are further configured for at least one of:
providing visualization of the anomaly and of the root cause of the anomaly to a user, or
providing a natural language description of the anomaly and of the root cause of the anomaly to the user.
